(19) United States
(12) Patent Application Publication
(10) Pub. No.: US 2006/0225962 A1
(43) Pub. Date: Oct. 12, 2006

(54) Ladder stand-off

(76) Inventors: Philip Orlando Underhill, Exeter, NH (US); Pamela A. Heafey, Lynnfield, MA (US); Michael S. Heafey, Quincy, MA (US)

Correspondence Address: PATRICK R. SCANLON;PRETI FLAHERTY BELIVEAU PACHIOS & HALEY LLP, ONE CITY CENTER, PORTLAND, ME, 04112-9546, US

(21) Appl. No.: 11/445,637

(22) Filed: Jun. 2, 2006

Related U.S. Application Data
(63) Continuation-in-part of application No. 10/946,136, filed on Sep. 21, 2004.
Application No. 10/946,136 is a continuation-in-part of application No. 10/680,648, filed on Oct. 7, 2003, now Pat. No. 6,962,237.

(51) Int. Cl. E06C 7/06

(52) U.S. Cl. 182/214

(57) ABSTRACT

A ladder stand-off includes a beam and first and second arms extending from the beam. A contact element is attached to the outer end of each of the first and second arms. Each contact element has first, second and third contact surfaces, with the first contact surface being substantially parallel to the beam and the second and third contact surfaces defining respective 45 degree angles with the first contact surface.

### CROSS REFERENCES TO RELATED APPLICATIONS

This application is a Continuation-In-Part of copending U.S. patent application Ser. No. 10/946,136, filed Sep. 21, 2004, which is a Continuation-In-Part of U.S. patent application Ser. No. 10/680,648, filed Oct. 7, 2003 and now U.S. Pat. No. 6,962,237.

### BACKGROUND OF THE INVENTION

This invention relates generally to ladder stand-offs and more particularly to ladder stand-offs useful in corner applications.

Ladders are commonly used for many tasks to enable the user to reach locations that otherwise could not be reached. One of the most common types of ladders is the lean-on ladder which comprises a pair of laterally spaced side rails interconnected by a plurality of longitudinally spaced rungs. In use, the bottom of the ladder is supported on the ground or a floor and the top of the ladder is placed against a wall or similar vertical surface. Generally, lean-on ladders should be oriented at an angle of lean (i.e., the angle between the ladder and the ground or floor) of approximately 70-80 degrees for safe and stable deployment.

It is known to use ladder attachments such as stand-offs with lean-on ladders to increase ladder stability. Such devices are attached to the upper portion of the ladder and position the ladder away from the wall that it is leaned against. Stand-offs designed to be used in corner applications have also been proposed. However, many known stand-offs are not readily used with both flat and corner surfaces or require manual adjustment of various moving parts to permit use with different surfaces. Such moving parts are susceptible to becoming lost or broken. Many current stand-offs are also big and bulky and thus not suitable for use in tight spaces.

Accordingly, there is a need for a ladder stand-off that is compact and easy to use and can be used on both flat and corner surfaces without excessive adjustable parts.

### SUMMARY OF THE INVENTION

The above-mentioned need is met by the present invention, which provides a ladder stand-off having a beam and first and second arms extending from the beam. A contact element is attached to the outer end of each of the first and second arms. Each contact element has first, second and third contact surfaces, with the first contact surface being substantially parallel to the beam and the second and third contact surfaces defining respective 45 degree angles with the first contact surface. The contact elements are preferably, although not necessarily, made of a resilient material such as rubber.

In one possible embodiment, the first arm is fixedly connected to a first support beam to define a first stand-off section that is slidingly mounted on the beam, and the second arm is fixedly connected to a second support beam to define a second stand-off section that is also slidingly mounted on the beam. Means for fixing each stand-off section relative to the extension beam are included.

The present invention and its advantages over the prior art will be more readily understood upon reading the following detailed description and the appended claims with reference to the accompanying drawings.

### DESCRIPTION OF THE DRAWINGS

The subject matter that is regarded as the invention is particularly pointed out and distinctly claimed in the concluding part of the specification. The invention, however, may be best understood by reference to the following description taken in conjunction with the accompanying drawing figures in which:

FIG. 1 is a perspective view of a ladder stand-off detachably secured to a ladder.

FIG. 2 is a side view of the ladder stand-off of FIG. 1, separate from the ladder.

FIG. 3 is an exploded view of the ladder stand-off of FIG. 1.

FIG. 4 is a top view of the ladder stand-off, in a compact mode, in use with a flat wall.

FIG. 5 is a top view of the ladder stand-off, in an expanded mode, in use with a flat wall.

FIG. 6 is a top view of the ladder stand-off in use with an outside corner.

FIG. 7 is a top view of the ladder stand-off in use with an inside corner.

FIG. 8 is an enlarged top view of a contact element used with the ladder stand-off.

FIG. 9 is a perspective view of the contact element.

FIG. 10 is a top view of a ladder stand-off employing a longer extension beam.

FIG. 11 shows a ladder having the ladder stand-off in use.

### DETAILED DESCRIPTION OF THE INVENTION

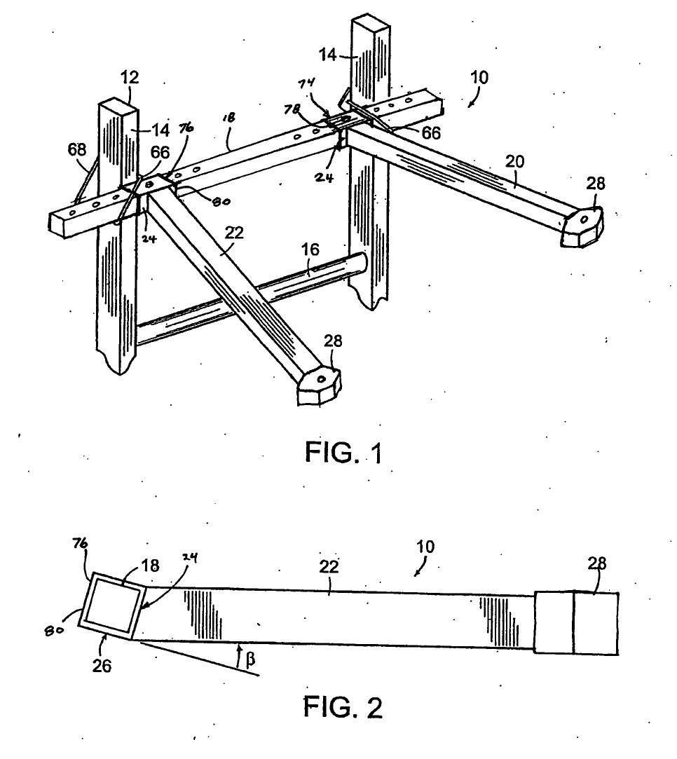

Referring to the drawings wherein identical reference numerals denote the same elements throughout the various views, FIG. 1 shows a ladder stand-off 10 detachably secured to a conventional ladder 12. The ladder 12 illustrated in the Figures is a common lean-on ladder having a pair of laterally spaced side rails 14 interconnected by a plurality of longitudinally spaced rungs 16. The ladder stand-off 10 can be used with extendible and non-extendible ladders. It is also possible to use the ladder stand-off 10 with folding step ladders when folded closed and used in the manner of a lean-on ladder (i.e., leaned against a wall or other vertical surface).

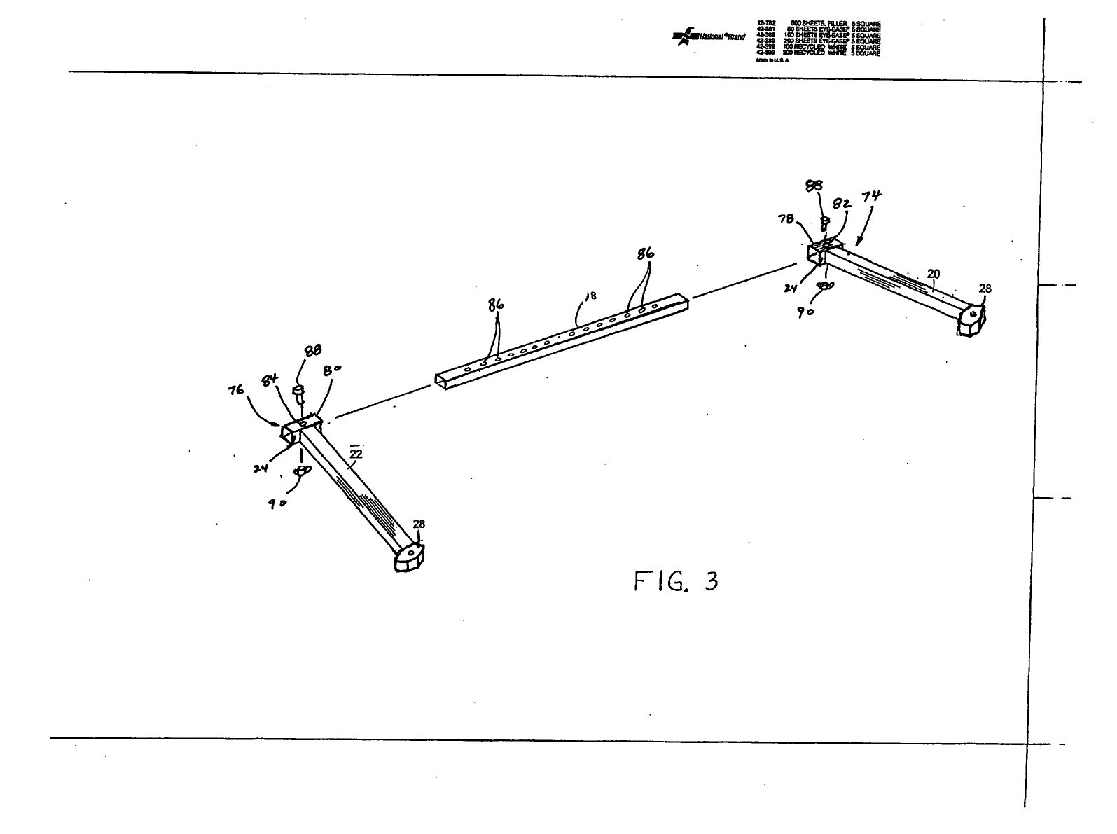

Referring to FIGS. 1-7, the ladder stand-off 10 includes an extension beam 18 and first and second stand-off sections 74 and 76 slidingly mounted on the extension beam 18. The extension beam 18 should be suitably strong and rigid and is preferably a straight piece having a predetermined length. In one embodiment, the extension beam 18 can comprise square aluminum tubing, which is suitably strong and rigid while being relatively lightweight. Alternatively, the extension beam 18 can be made from a composite material, such as fiberglass or another reinforced plastic, which is also suitably strong and rigid while being relatively lightweight. Non-conductive composite materials could also be used and would enable safer use of the stand-off 10 near electrical equipment. The first stand-off section 74 includes a first support beam 78 and a first arm 20 fixedly connected to the first support beam 78. The second stand-off section 76 includes a second support beam 80 and a second arm 22 fixedly connected to the second support beam 80. The first and second support beams 78 and 80 should also be suitably strong and rigid; as with the extension beam 18, square aluminum or composite tubing are suitable materials. The two arms 20 and 22 generally have similar material characteristics and are preferably, although not necessarily, made of the same material as the support beams 78 and 80.

In one embodiment, the first and second support beams 78 and 80 are slidingly mounted on the extension beam 18. To accomplish this, the support beams 78 and 80 are open at the ends so as to define hollow interiors that are shaped to match the exterior shape of the extension beam 18. The cross-sectional dimensions of the support beams 78 and 80 are slightly greater than that of the extension beam 18. This permits both the first and second support beams 78 and 80 to fit over the extension beam 18. That is, the extension beam 18 is slidingly received in the hollow interiors of the first and second support beams 78 and 80. Accordingly, the first and second stand-off sections 74 and 76 are slidingly mounted on the extension beam 18. Furthermore, the first and second support beams 78 and 80 are each substantially shorter than the extension beam 18 and are generally just slightly longer than the width of the respective arm 20, 22.

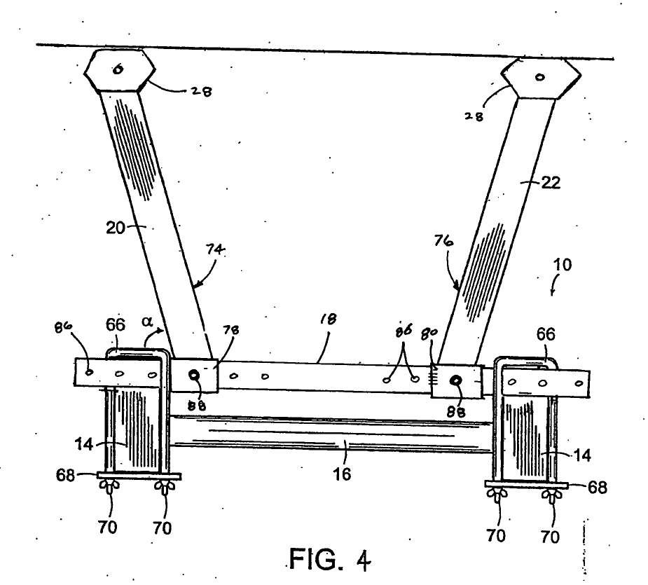

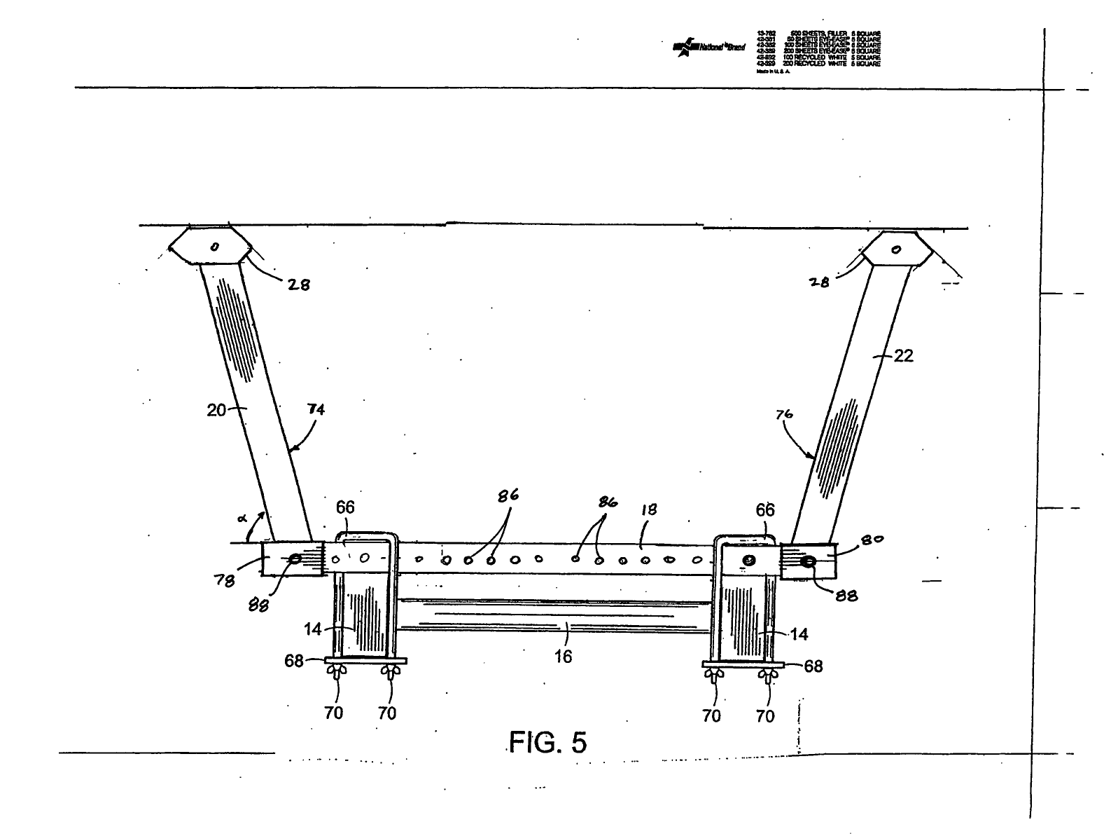

With this arrangement, the positions of the first and second stand-off sections 74 and 76 on the extension beam 18 can be adjusted. That is, each section 74, 76 can be secured in a number of positions along the length of the extension beam 18. For instance, FIG. 4 shows the two stand-off sections 74 and 76 positioned towards the center of the extension beam 18, thereby defining a compact mode of the ladder stand-off 10, although the two sections 74 and 76 could be positioned even closer together if desired. FIG. 5 shows the ladder stand-off 10 in an expanded mode, that is, with the two stand-off sections 74 and 76 positioned farther out on the extension beam 18 so that the distance between the distal ends of the arms 20 and 22 (referred to herein as the span of the ladder stand-off 10) is greater than that it of the compact mode.

The ladder stand-off 10 further includes means for fixing the first and second stand-off sections 74 and 76 relative to the extension beam 18. One possible embodiment of a means for fixing the stand-off sections 74 and 76 includes a hole 82 formed through the first support beam 78, a hole 84 formed through the second support beam 80, and a plurality of holes 86 formed through, and spaced longitudinally along, the extension beam 18. The first stand-off section 74 is fixed relative to the extension beam 18 by aligning the hole 82 with a selected one of the holes 86, inserting a bolt 88 (such as a carriage bolt) through the aligned holes 82, 86, and securing the bolt 88 with a wing nut 90. Similarly, the second stand-off section 76 is fixed relative to the extension beam 18 by aligning the hole 84 with another selected one of the holes 86, inserting a bolt 88 through the aligned holes 84, 86, and securing the bolt 88 with a wing nut 90. In both instances, the bolts 88 are arranged with the bolt heads on the upper surfaces of the support beams 78 and 80 and the wing nuts 90 underneath so that the wing nuts 90 are less likely to interfere with the user. Alternatively, the first and second stand-off sections 74 and 76 can be secured to the extension beam 18 using clevis pins that extend through the aligned holes and clip on the bottom. Pins retained by a spring clip or cotter pin could be used as an alternative to threaded bolts. Because of the plurality of holes 86 in the extension beam 18, the stand-off sections 74 and 76 can be selectively positioned in a number of locations on the extension beam 18. This allows the ladder stand-off 10 to be set up with spans of various widths, depending on the needed application. For example, when working in tight spaces, the ladder stand-off 10 can be set up in the compact mode shown in FIG. 4. When needing to span a wide object such as a window, the ladder stand-off 10 can be set up in an expanded mode, such as that shown in FIG. 5.

Each of the first and second arms 20 and 22 is joined, at a first end thereof, to a first surface 24 of its corresponding support beam 78, 80. The first and second arms 20 and 22 are fixedly joined, such as by welding or the like, to the corresponding support beam 78, 80. The first arm 20 is joined to the first support beam 78 at a first connection point between the two ends of the first support beam 78, so as to be positioned approximately in the center of the first support beam 78. The second arm 22 is joined to the second support beam 80 at a second connection point between the two ends of the second support beam 80, so as to be positioned approximately in the center of the second support beam 80. The first and second connection points are spaced apart a predetermined distance (which distance is dependent on the positioning of the stand-off sections 74 and 76 relative to the extension beam 18). The two stand-off sections 74 and 76 are positioned on the extension beam 18 so as to permit the ladder stand-off 10 to be attached to a ladder, in a manner described below.

The first and second arms 20 and 22 extend outwardly from the corresponding first beam surface 24 so as to be angularly divergent with respect to each other, generally defining an angle therebetween that is less than 90 degrees. Specifically, the first and second arms 20 and 22 each forms an outside angle α with the corresponding first beam surface 24 (which extends in a direction parallel to the longitudinal axis of the extension beam 18) that is less than 90 degrees. In this case, the distal ends of the first and second arms 20 and 22 are spaced apart a distance that is greater than the distance that the fixed ends of the first and second arms 20 and 22 are spaced apart. The angle α is generally in the range of 70-85 degrees. The first and second arms 20 and 22 are also angled relative to a second surface 26 of the corresponding support beam 78, 80, which is perpendicular to the first beam surface 24. As best seen in FIG. 2, the first and second arms 20 and 22 are both angled upward at an angle β relative to the corresponding second beam surface 26. The angle β will typically be in the range of 10-20 degrees, depending on the desired angle of lean that the ladder 12 is to make with respect to the ground or floor.

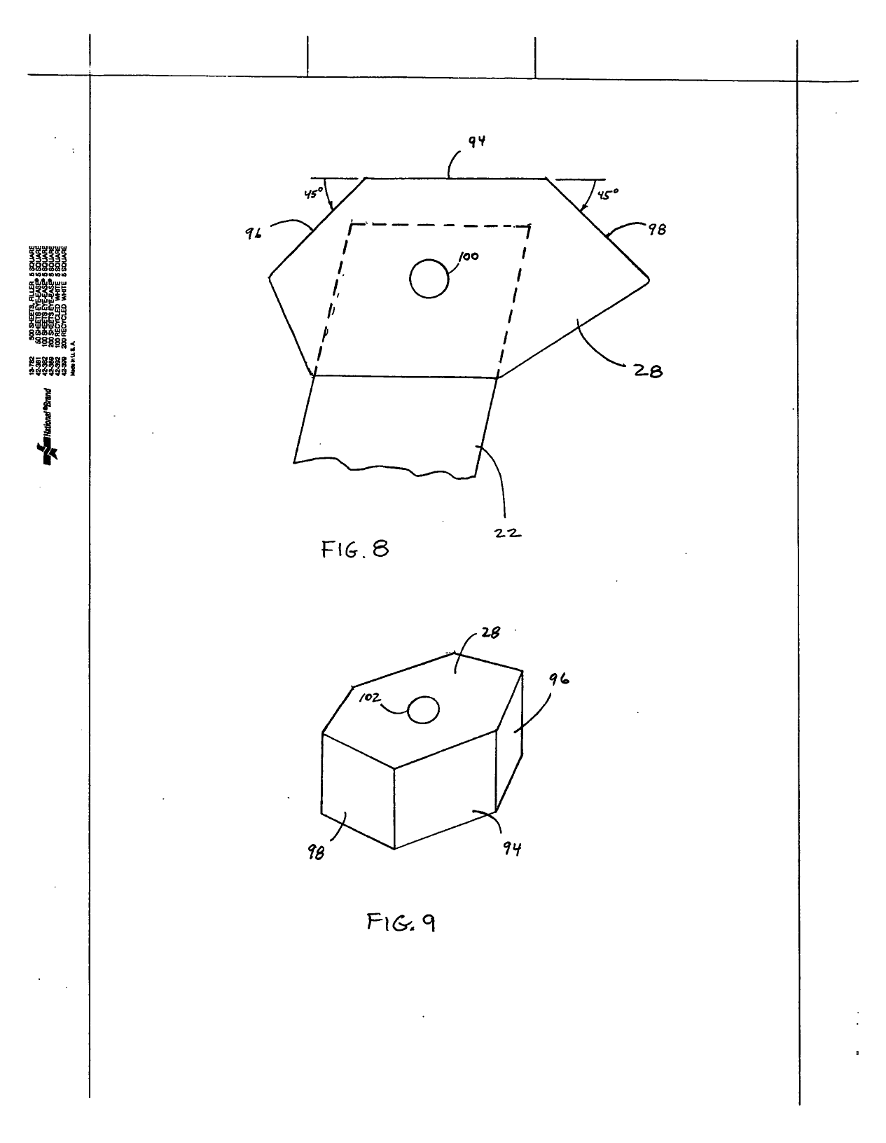

The ladder stand-off 10 includes a contact element 28 connected to the distal end of each of the first and second arms 20 and 22. Referring to FIGS. 8 and 9, each contact element 28 comprises a hexagonal shaped member having three primary contact surfaces 94, 96 and 98. Each contact element 28 has an open end opposite the first contact surface 94 so that the contact element 28 can fit over the end of the corresponding arm 20, 22. Pins or bolts 100 extend through holes 102 in the contact elements 28 to secure the contact elements 28 to the respective arm 20, 22. Other types of fastening means can alternatively be used. For example, the contact elements 28 could be secured to the respective arm 20, 22 by means of a compression fit.

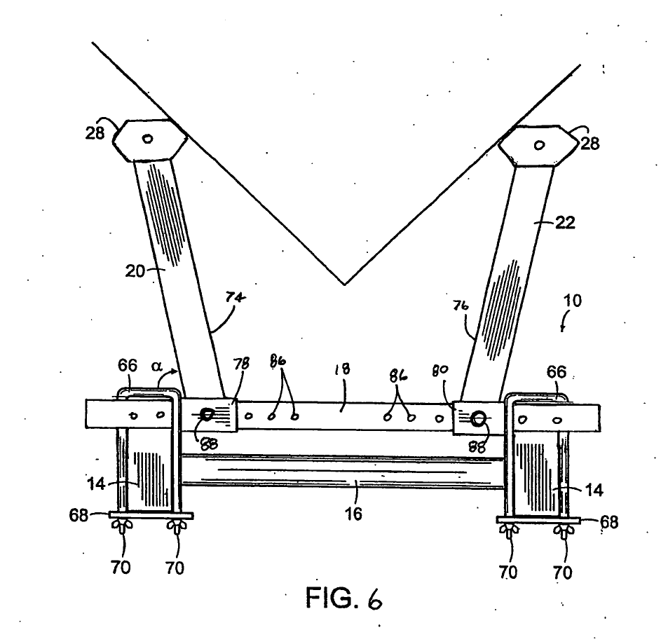

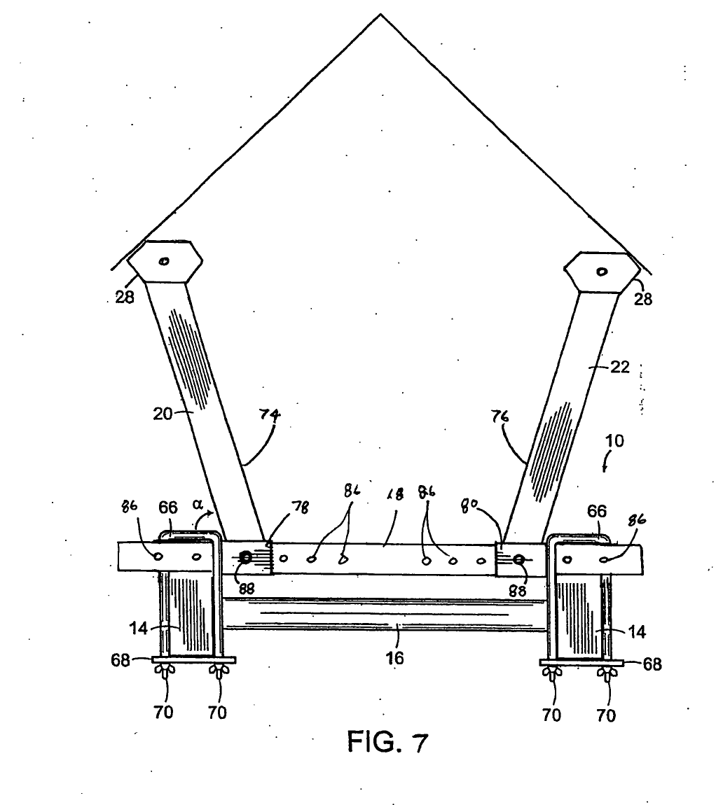

The contact elements 28 are designed so that when mounted on the arms 20, 22, the first contact surface 94 is substantially parallel to the extension beam 18. The second and third contact surfaces 96 and 98 define respective 45 degree angles with the first contact surface 94. This tri-surface configuration permits the stand-off 10 to be used with flat surfaces, outside corners, and inside corners. Specifically, the first contact surface 94 engages flat support surfaces (FIGS. 4 and 5), the second contact surface 96 engages outside corners (FIG. 6), and the third contact surface 98 engages inside corners (FIG. 7). The contact surfaces 94, 96, 98 are sized to provide sufficient contact area to ensure stable, slip-free contact with the support surface. For example, each contact surface 94, 96, 98 could be approximately 1¾ inches high and 1½ inches wide. The contact surfaces 94, 96, 98 can also be corrugated to enhance contact with the support surface, with the corrugations extending vertically so that any water or moisture present will be free to drain away.

The contact elements 28 are preferably made of a resilient material so as to protect the surface the ladder 12 is leaned against when in use. Suitable materials include fiberglass and plastic materials, as well as neoprene, urethane, nitrile, and Hypalon thermoset rubbers. A number of thermoplastic rubber materials can also be used. Durometers in the range of approximately 50-95 Shore A are generally preferred to avoid damage to fragile support surfaces such as vinyl siding. One preferred material is a urethane thermoset rubber having a durometer or hardness in the range of 75-85 Shore A.

The ladder stand-off 10 is generally sized based on the size of the ladder that it is to be used with. In the illustrated embodiment, for example, the span of the ladder stand-off 10 (i.e., the distance between the distal ends of the first and second arms 20 and 22) in the compact mode is preferably equal to, or slightly greater than, the width of the ladder 12, while being less than the length of the extension beam 18. For example, for a ladder that is 19 inches wide (which is a typical ladder width), an extension beam length of 21 inches would be desirable. The distance between the first and second connection points of the fixed ends of the first and second arms 20 and 22, with the ladder stand-off in a compact mode, is approximately 12 inches. The arms 20 and 22 in the illustrated embodiment are 13.5 inches long and define an angle α of 75 degrees, which results in a compact mode span of about 19 inches. Many other sizes and dimensions are possible. For instance the extension beam length could be significantly greater than 21 inches.

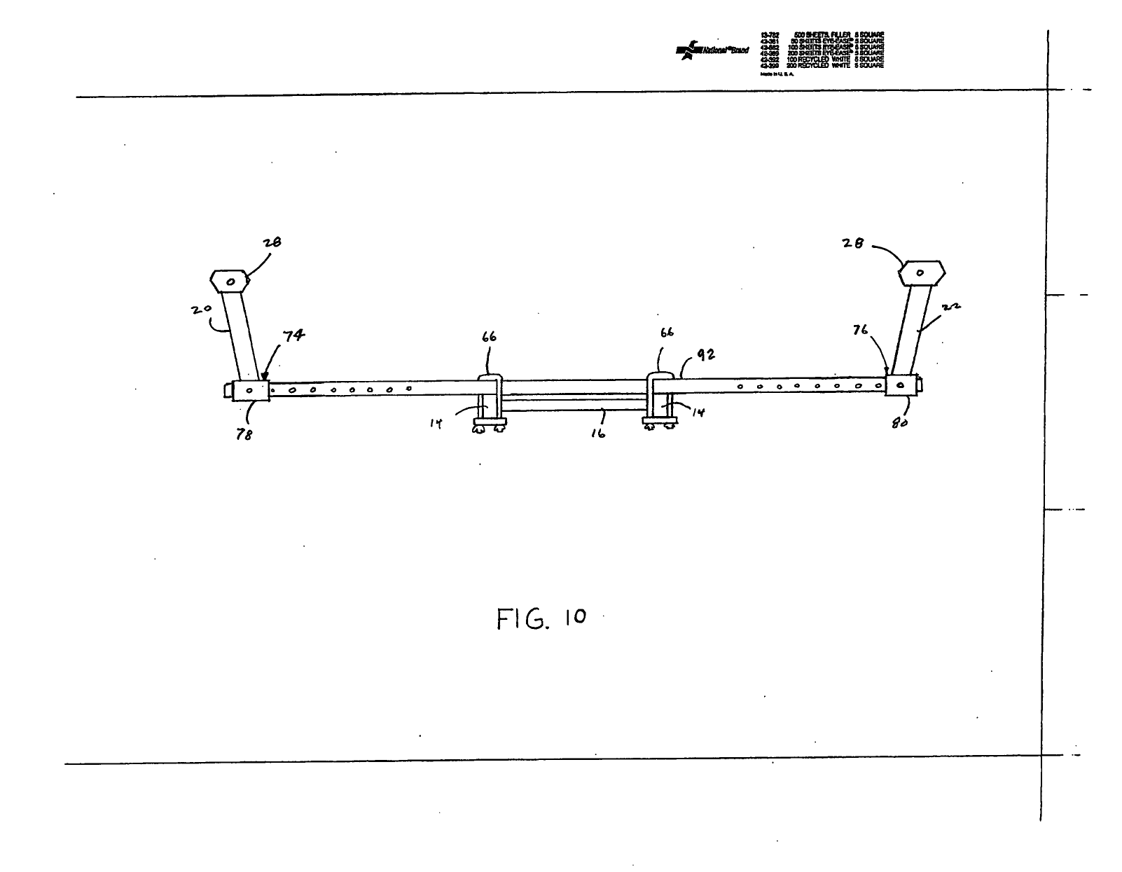

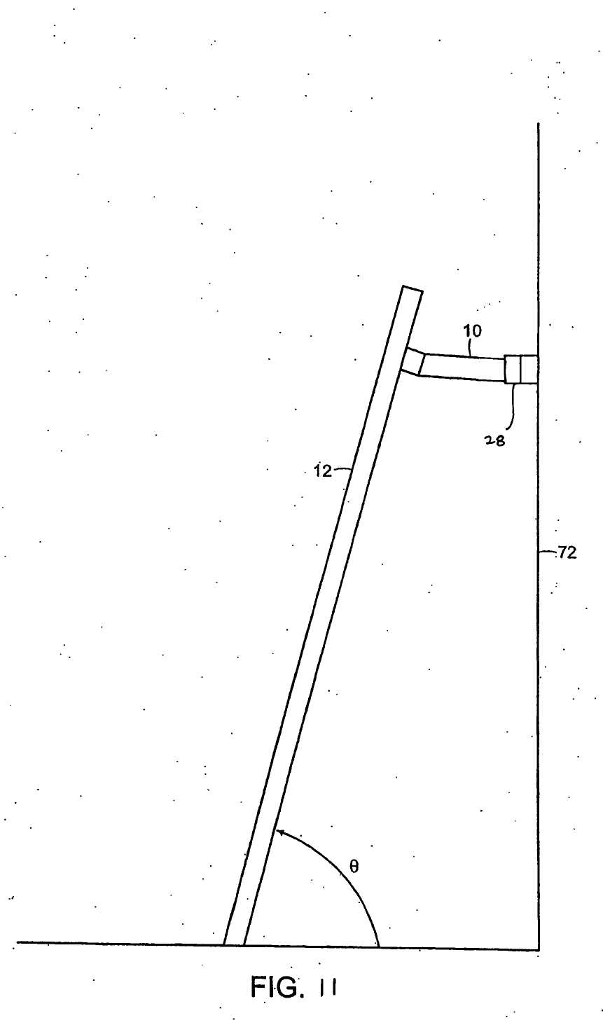

The ladder stand-off 10 can alternatively be provided with multiple extension beams of different lengths to provide even more variability in the span of the device. For instance, in addition to the extension beam 18, the ladder stand-off 10 could be provided with a second, longer extension beam 92 (shown in FIG. 10) that is interchangeable with the first extension beam 18. This would provide a ladder stand-off kit having component parts capable of being assembled into a ladder stand-off. Specifically, either one of the first and second extension beams 18 and 92 could be assembled with the first and second stand-off sections 74 and 76 to form a ladder stand-off. The second extension beam 92 has the same construction and cross-section dimensions as the first extension beam 18, but is longer in length. By way of example, the second extension beam 92 could be four feet long. When the user desires a greater span, the first and second stand-off sections 74 and 76 are removed from the first extension beam 18, and mounted on the second extension beam 92. As with the first extension beam 18, the two sections 74 and 76 can be selectively positioned in a number of locations on the second extension beam 92.

The ladder stand-off 10 is detachably secured to the ladder 12 through any suitable fastening means. One possible means for detachably securing the ladder stand-off 10 to the ladder 12 comprises a pair of U-bolts 66 that are threaded at both terminal ends, a pair of flat braces 68 having laterally spaced holes for receiving the legs of the U-bolts 66, and four threaded elements such as wing nuts 70. Each U-bolt 66 is placed over the extension beam 18, 92 so that the bottom of the “U” abuts the forward-facing beam surface and the two legs of the U-bolt 66 extend over the extension beam 18, 92 and on opposite sides of the respective side rails 14. The flat braces 68 are mounted over the U-bolt legs so as to engage the back of the respective sides rails 14. Tightening the wing nuts 70 on the threaded legs of the U-bolts 66 thereby secures the extension beam 18, 92 to the side rails 14. The ladder stand-off 10 is preferably, but not necessarily, attached to the ladder 12 with the beam 18 adjacent to the top most of the ladder rungs 16. In this case, the innermost leg of each U-bolt 66 can be positioned over the rung 16 (as shown in the Figures) so as to prevent the ladder stand-off 10 from slipping downward relative to the ladder 12. Other means for detachably securing the ladder stand-off 10 to the ladder 12 can also be used.

With the ladder stand-off 10 detachably secured thereto, the ladder 12 is placed on a horizontal surface, such as the ground or floor, and leaned against a vertical surface 72 (see FIG. 11) so that the appropriate surfaces of each contact element 28 engage the vertical surface 72. The ladder 12 is oriented so that the contact surfaces are substantially flush against the vertical surface 72 and the arms 20 and 22 are parallel to the ground or floor or angled slightly downward as shown in FIG. 11. With this arrangement, the upward angle β of each arm 20, 22 relative to the beam 18 determines the angle of lean θ of the ladder 12 with respect to the ground or floor. For example, if the upward angle β is 12 degrees, then the ladder 12 would define an angle of 78 degrees with the ground or floor if the arms 20 and 22 are parallel to the ground or floor or an angle of about 75 degrees if the arms 20 and 22 are angled downward about three degrees.

The tri-surface configuration of the contact elements 28 allows the ladder stand-off 10 to be used with a variety of vertical surfaces, including a flat wall (FIGS. 4 and 5), an outside corner (FIG. 6), and an inside corner (FIG. 7). In addition to this versatility, the ladder stand-off 10 provides the advantage of being relatively compact. Thus, when using a ladder equipped with the ladder stand-off 10, it is easier to avoid hitting or becoming entangled with wires, tree limbs or other such obstacles around the work site. The narrow spacing of the arms 20 and 22 is helpful when working in tight spaces due to structural characteristics of the work site, such as a window set very close to a corner. Alternatively, when compactness is not an issue, the ladder stand-off 10 can be adjusted to provide a wide span. Another advantage of the ladder stand-off 10 is that because there are very few moving parts, there is little chance of parts becoming lost or damaged.

The ladder stand-off 10 can also be used in the manner of a ridge hook. That is, with the ladder stand-off 10 attached, the ladder 12 can be placed flat on a pitched roof with the ladder stand-off 10 situated over the peak of the roof. The arms 20 and 22 are oriented downward so that the contact elements 28 abut the roof on the other side of the peak. With this set-up, the ladder stand-off 10 will secure the ladder 12 on the roof, allowing a worker to walk on the ladder 12. When used in this manner, the innermost leg of each U-bolt 66 would preferably be positioned under the adjacent ladder rung 16 so as to prevent the ladder 12 from slipping downward relative to the ladder stand-off 10.

While specific embodiments of the present invention have been described, it will be apparent to those skilled in the art that various modifications thereto can be made without departing from the spirit and scope of the invention as defined in the appended claims.

What is claimed is:

1. A ladder stand-off comprising:
a beam;
a first arm connected at a first end thereof to said beam;
a second arm connected at a first end thereof to said beam; and
a contact element attached to a second end of each of said first and second arms, wherein each contact element has first, second and third contact surfaces, said first contact surface being substantially parallel to said beam and said second and third contact surfaces defining respective 45 degree angles with said first contact surface.

2. The ladder stand-off of claim 1 wherein said contact elements are made of a resilient material.

3. The ladder stand-off of claim 2 wherein said resilient material is a rubber.

4. The ladder stand-off of claim 3 wherein said rubber is a urethane thermoset rubber having a durometer in the range of 75-85 Shore A.

5. The ladder stand-off of claim 1 wherein said contact elements are hexagonal shaped members.

6. The ladder stand-off of claim 1 wherein each contact element has an open end opposite said first contact surface that receives said second end of said first or second arm.

7. The ladder stand-off of claim 1 wherein said first and second arms extend outward from said beam so as to be angularly divergent with respect to each other.

8. The ladder stand-off of claim 1 further comprising means for detachably securing said beam to a ladder.

9. The ladder stand-off of claim 1 wherein said beam, said first arm, and said second arm are made of a composite tubing material.

10. A ladder stand-off comprising:
an extension beam;
a first stand-off section slidingly mounted on said extension beam, said first stand-off section including a first support beam, a first arm fixedly connected at a first end thereof to said first support beam and a first contact element attached to a second end of said first arm;
a second stand-off section slidingly mounted on said extension beam, said second stand-off section including a second support beam, a second arm fixedly connected at a first end thereof to said second support beam and a second contact element attached to a second end of said second arm;
wherein said first and second contact elements each has first, second and third contact surfaces, said first contact surfaces being substantially parallel to said extension beam and said second and third contact surfaces defining respective 45 degree angles with the corresponding first contact surface; and
means for detachably securing said ladder stand-off to a ladder.

11. The ladder stand-off of claim 10 wherein said first and second contact elements are made of a resilient material.

12. The ladder stand-off of claim 11 wherein said resilient material is a rubber.

13. The ladder stand-off of claim 12 wherein said rubber is a urethane thermoset rubber having a durometer in the range of 75-85 Shore A.

14. The ladder stand-off of claim 10 wherein said first and second contact elements are hexagonal shaped members.

15. The ladder stand-off of claim 10 wherein each contact element has an open end opposite said first contact surface that receives said second end of said first or second arm.

16. The ladder stand-off of claim 10 further comprising means for fixing said first stand-off section relative to said extension beam and means for fixing said second stand-off section relative to said extension beam.

17. The ladder stand-off of claim 10 wherein said first and second arms are angularly divergent with respect to each other.

18. The ladder stand-off of claim 17 wherein said first and second arms define an angle therebetween that is less than 90 degrees.

19. The ladder stand-off of claim 10 wherein said first support beam defines a first hollow interior and a first portion of said extension beam is slidingly received in said first hollow interior, and said second support beam defines a second hollow interior and a second portion of said extension beam is slidingly received in said second hollow interior.

20. The ladder stand-off of claim 10 wherein said extension beam, said first stand-off section, and said second stand-off section are made of a composite tubing material.
